(19) United States
(12) Patent Application Publication
(10) Pub. No.: US 2026/0164119 A1
(43) Pub. Date: Jun. 11, 2026

(54) IMAGE CAPTURE APPARATUS, IMAGE CAPTURE APPARATUS CONTROL METHOD, AND NON-TRANSITORY COMPUTER READABLE MEDIUM

(71) Applicant: CANON KABUSHIKI KAISHA, Tokyo (JP)

(72) Inventor: TAKUMI IKO, Kanagawa (JP)

(21) Appl. No.: 19/408,633

(22) Filed: Dec. 4, 2025

(30) Foreign Application Priority Data
Dec. 9, 2024 (JP) 2024-214407

(51) Int. Cl. H04N 23/65; H04N 23/62; H04N 23/661; H04N 23/617

(52) U.S. Cl. CPC H04N 23/65; H04N 23/62; H04N 23/661; H04N 23/617

(57) ABSTRACT

An image capture apparatus includes a communication device that communicates with an external apparatus outside the image capture apparatus, a plurality of operation components including a power switching component that switches power of the image capture apparatus on and off, a processor causes the image capture apparatus to execute control processing in which in a first power-off state capable of accepting operations from a user on a first number of operation components including the power switching component, the communication device performs communication with the external apparatus, and in a second power-off state capable of accepting operations from the user on a second number of operation components including the power switching component, which is larger than the first number, the communication device is controlled so as not to perform communication with the external apparatus.

### BACKGROUND

### Field of the Technology

The present disclosure relates to an image capture apparatus capable of communicating with an external apparatus, an image capture apparatus control method, and a non-transitory computer readable medium.

### Description of Related Art

In image capture apparatuses, various techniques have been proposed for controlling the operations of an image capture apparatus when the power is off. Japanese Patent Laid-Open No. 2010-41287 describes a technique related to an image capture apparatus that, when an external power source is connected while the image capture apparatus is power-off, sets a standby time, during which image data cannot be transmitted through wireless communication, to a necessary minimum, and enables a swift transition to a charging operation. Japanese Patent Laid-Open No. 2007-96854 describes a technique related to an image capture apparatus that, after a predetermined time has elapsed since a power source is turned off, transmits image data if it is determined that wireless communication is possible.

However, according to the conventional techniques disclosed in Japanese Patent Laid-Open No. 2010-41287 and Japanese Patent Laid-Open No. 2007-96854, an image capture apparatus performs wireless communication when a condition for starting a wireless connection is met while the power is off; therefore, there are cases where it may take time to return to a state capable of image capture upon receiving an operation from a user.

### SUMMARY

The technique of the present disclosure has been achieved in view of the above, and provides an image capture apparatus that performs wireless communication when the power is off, and that can further shorten the time required to return to a state capable of image capture.

According to some embodiments, an image capture apparatus includes a communication device that communicates with an external apparatus outside the image capture apparatus, a plurality of operation components including a power switching component that switches power of the image capture apparatus on and off, a processor, and a memory storing a program which, when executed by the processor, causes the image capture apparatus to execute control processing in which in a first power-off state capable of accepting operations from a user on a first number of operation components including the power switching component, the communication device performs communication with the external apparatus, and in a second power-off state capable of accepting operations from the user on a second number of operation components including the power switching component, which is larger than the first number, the communication device is controlled so as not to perform communication with the external apparatus.

Features of the present disclosure will become apparent from the following description of embodiments with reference to the attached drawings. The following description of embodiments is described by way of example.

### BRIEF DESCRIPTION OF THE DRAWINGS

FIGS. 1A to 1C are diagrams illustrating an example of a configuration of a digital camera according to a first embodiment.

FIG. 2 is a diagram schematically illustrating an example of a configuration of a communication system according to the first embodiment.

FIG. 3 is a flowchart illustrating an example of processing executed by the digital camera according to the first embodiment.

FIG. 4 is a flowchart illustrating an example of processing executed by a digital camera according to a second embodiment.

### DESCRIPTION OF THE EMBODIMENTS

Hereinafter, preferred embodiments of the technique of the present disclosure will be described in detail with reference to the accompanying drawings. Note that the following embodiments do not limit the disclosure according to the aspects. While a plurality of features are described in the embodiments, all of the plurality of features are not necessarily essential to the present disclosure and the plurality of features may be combined with each other in any way. Moreover, in the accompanying drawings, the same reference numerals are assigned to the same or similar components, and redundant descriptions thereof are omitted.

In the embodiments described below, a digital camera is used as an image capture apparatus, a server is used as an external apparatus, and a communication system is assumed in which the digital camera is communicably connected to the server via a network. Note that in the following embodiments, a server that communicates with an image capture apparatus will be described as an example of an external apparatus, but the external apparatus is not limited to this, and may be an information processing apparatus such as a tablet device or a personal computer.

### First Embodiment

In a communication system 1 according to the first embodiment, when an external power source is connected to a digital camera 100, which is an image capture apparatus, the digital camera 100 determines, before transmitting an image to a server 202, whether to transmit an image that has not been transmitted to the server 202, which is an external apparatus.

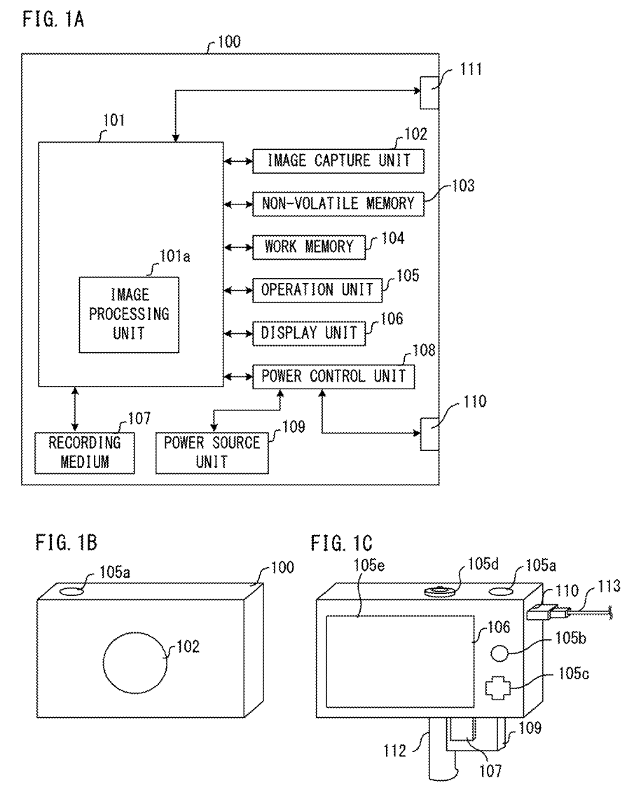

(Configuration of Digital Camera 100) First, the configuration and functions of the digital camera 100 included in the communication system 1 of the present embodiment will be described with reference to FIGS. 1A to 1C.

The control unit 101 of the digital camera 100 is a central processing unit (CPU) that integrates and controls each unit of the digital camera 100. In addition, the control unit 101 is a control means that implements communication processing and control processing, which will be described later, by executing a program stored in a non-volatile memory 103 described later. Note that the digital camera 100 may be configured such that a plurality of pieces of hardware share the control processing of the digital camera 100, instead of the entire digital camera 100 being controlled by the control unit 101.

An image capture unit 102 has a lens group including lenses such as a zoom lens and a focus lens, and a shutter provided with a diaphragm function. The image capture unit 102 also has an image sensor composed of a CCD (Charged Coupled Device) or the like that converts a subject image into an electrical signal. CMOS (Complementary Metal-Oxide Semiconductor) may be used instead of the CCD. In addition, the image capture unit 102 has an A/D converter that converts an analog image signal output from the image sensor into a digital signal. Under the control of the control unit 101, the image capture unit 102 converts, by means of the image sensor, subject image light formed by the lens group into an electrical signal, performs noise reduction processing and the like, and outputs image data composed of digital signals.

The control unit 101 has an image processing unit 101a. The image processing unit 101a performs development processing such as exposure correction, white balance (WB), and sharpness on the image data (RAW data) captured by the image capture unit 102, thereby generating image data. The image data generated by the image processing unit 101a is recorded on a recording medium 107. In addition, the image data subjected to development processing is recorded on the recording medium 107 compliant with the DCF (Design Rule for Camera File System) standard.

The control unit 101 performs a predetermined arithmetic processing using the generated image data, and performs autofocus (AF) processing and automatic exposure (AE) processing by controlling the focus lens, diaphragm and shutter of the image capture unit 102 on the basis of the obtained arithmetic results.

The non-volatile memory 103 is an electrically erasable and recordable memory, for example, an EEPROM (Electrically Erasable Programmable Read-Only Memory) and the like are used. Constants, programs, and the like for the operation of the control unit 101 are recorded in non-volatile memory 103. Here, the programs are programs for executing communication processing and control processing, which will be described later in the present embodiment.

A work memory 104 is used as a work area that load constants and variables for the operation of the control unit 101, programs read from the non-volatile memory 103, and the like. In addition, the work memory 104 is used as a buffer memory for temporarily holding image data captured by the image capture unit 102, and an image display memory for a display unit 106.

Note that an operation unit 105 includes a plurality of operation components such as various switches, buttons, touch panels, levers and the like that accept various operations from a user. For example, as illustrated in FIGS. 1B and 1C, the operation unit 105 includes a shutter button 105a for capturing an image, a reproduction button 105b for reproducing the captured image, and a 4-direction key 105c consisting of upper, lower, left and right buttons for performing various settings of the camera. Note that FIG. 1C illustrates a state in which an accommodation unit cover 112 of the recording medium 107 and a power source unit 109 is opened and the recording medium 107 and a part of the power source unit 109 are taken out of an accommodating unit (not illustrated). In addition, FIG. 1C illustrates a state where a cable 113 for connecting to an external power source (not illustrated) is connected to a power supply unit 110.

The operation unit 105 includes a power lever 105d, which is a power switching component that turns on and off the power source of the digital camera 100. Further, a touch panel 105e integrally formed with the display unit 106 which will be described later is also included in the operation unit 105. In addition, the operation unit 105 also includes a connection button dedicated for starting communication with an external apparatus such as the server 202.

The shutter button 105a generates a first shutter switch signal SW1 when it is in a so-called half press (image capture preparation instruction) state during operation by the user. The control unit 101, upon receiving the first shutter switch signal SW1, controls the image capture unit 102 to start image capture preparation operations such as AF processing or AE processing. In addition, when the user finishes the operation of the shutter button 105a and the shutter button 105a enters a so-called full press (image capture instruction) state, a second shutter switch signal SW2 is generated. The control unit 101, upon receiving the second shutter switch signal SW2, starts a series of image capture processing operations from reading out signals from the image capture unit 102 to writing image data to the recording medium 107.

The display unit 106 displays a viewfinder image at the time of image capture, a captured image, and characters for an interactive operation, and the like. The display unit 106 is, for example, a display device such as a liquid crystal display or an organic EL display. The display unit 106 may be integrally formed with the digital camera 100 or may be an external apparatus connected to the digital camera 100. The digital camera 100 only needs to be capable of connecting to the display unit 106 and to have the function of controlling the display of the display unit 106.

Image data output from the image capture unit 102 is recorded on the recording medium 107. The recording medium 107 may be a memory card, a hard disk drive, or the like mounted in the digital camera 100, or may be a flash memory or a hard disk drive built in to the digital camera 100. The digital camera 100 needs only to have at least a means for accessing the recording medium 107.

The power control unit 108 is composed of a battery detection circuit, a DC-DC converter, a switch circuit that switches blocks to be energized, etc., and performs detection of the presence or absence of a battery, the type of battery, and the remaining battery level. In addition, the power control unit 108 controls the DC-DC converter on the basis of the detection results and an instruction from the control unit 101, and supplies required power to each unit including the display unit 106 and the recording medium 107 for a required period. Alternatively, the power control unit 108 is also a charging means that receives the power supply from an external power source via a power supply unit 110 which will be described later, and charges a power source unit 109.

In the digital camera 100 of the present embodiment, when the power lever 105d is at the power-off position, the power control unit 108 sets the power supply to each unit to a necessary minimum. In addition, when the power of the digital camera 100 is turned off by means of the power lever 105d, the control unit 101 accepts only the operation of the power lever 105d, and does not accept the operations from the user on the operation units other than the power lever 105d, that is, the operation units other than the power switching component. Also, even when the power lever 105d is at the power-on position, if no operation of the operation unit 105 by the user has occurred for a predetermined time, the power control unit 108 sets the power supply to each unit to a level equivalent to that when the power is off, resulting in a so-called auto power-off state. Note that in a state in which the digital camera 100 is in the auto power-off state, if the user half-presses the shutter button 105a, the control unit 101 controls the power control unit 108 so that the digital camera transitions to the power-on state and prepares for image capture processing. In the present embodiment, when the power lever 105d is at the power-on position, if the digital camera can transition to a state equivalent to the auto power-off state by the user performing a predetermined operation on the operation unit 105, the state after transition is also referred to as the auto power-off state. In the digital camera 100, the auto power-off state is a power-off state in which the operations from the user on the operation units other than the power lever 105d, that is, the operation units other than the power switching component, are also accepted.

The power source unit 109 is composed of primary batteries such as alkaline batteries and lithium batteries, and secondary batteries such as NiCd batteries, NiMH batteries, and Li batteries. The power source unit 109 supplies required power to each unit via the power control unit 108, or receives power from the power supply unit 110.

The power supply unit 110 is an interface that is used when it is connected to an external power source via a wired cable. The power supply unit 110 is composed of a USB connector or the like, and connects to an external power source. The power supply unit 110 receives the power supply from an external power source by being connected to the external power source.

The connection unit 111 is an interface that functions as a communication device for communicably connecting to an external apparatus such as the server 202. The digital camera 100 of the present embodiment transmits and receives data to and from an external apparatus via the connection unit 111. For example, the digital camera 100 transmits image data to the server 202 via the connection unit 111, or receives data for an update of the firmware of the digital camera 100 from the server 202 via the connection unit 111.

Note that in the present embodiment, the connection unit 111 includes an interface for communicating with an external apparatus via a wireless LAN compliant with the IEEE802.11 standard. The control unit 101 implements wireless communication with an external apparatus by controlling the connection unit 111. Note that the communication method used for wireless communication is not limited to a wireless LAN, and for example, a standard for wired connection such as IEEE1394 standard may be used.

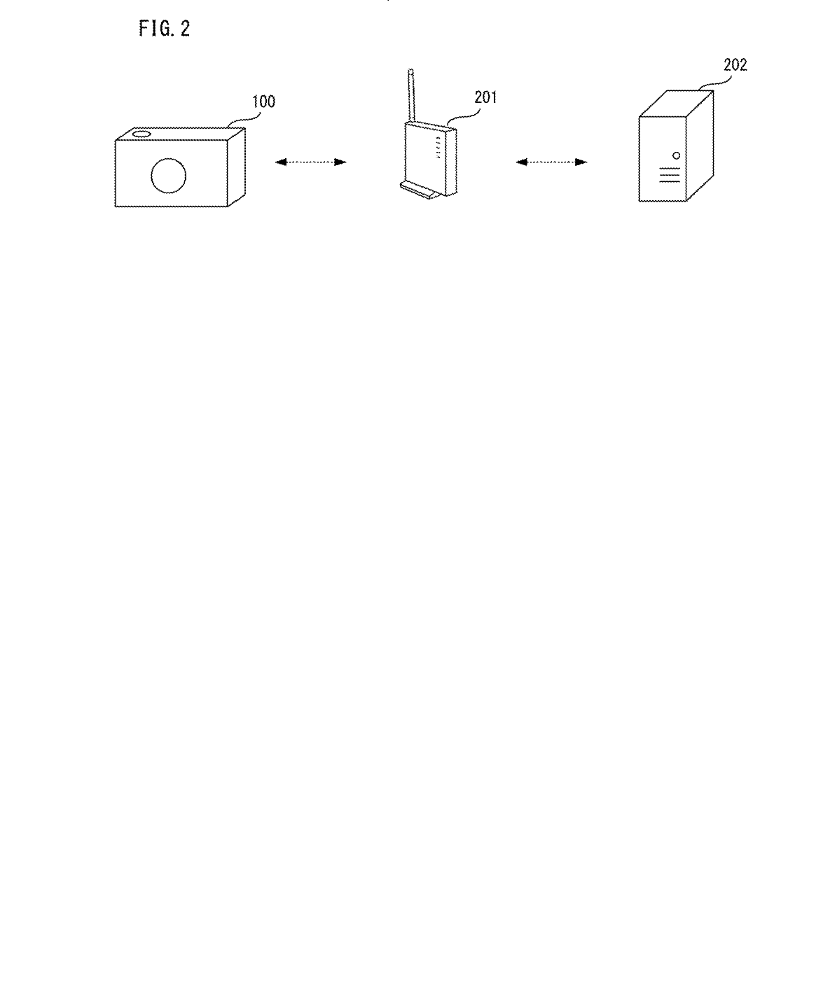

(System Configuration) Next, with reference to FIG. 2, the configuration in which the digital camera 100 and the server 202 are connected in the communication system 1 of the present embodiment will be described.

FIG. 2 illustrates that the communication system 1 has an access point (AP) 201, which is an example of an external relay apparatus that connects the digital camera 100 and the server 202. The AP 201 forms a wireless LAN network. The digital camera 100 detects a beacon signal periodically transmitted by means of the AP 201 and joins the wireless LAN network formed by the AP 201. At this time, the digital camera 100 communicates with the AP 201 via the connection unit 111.

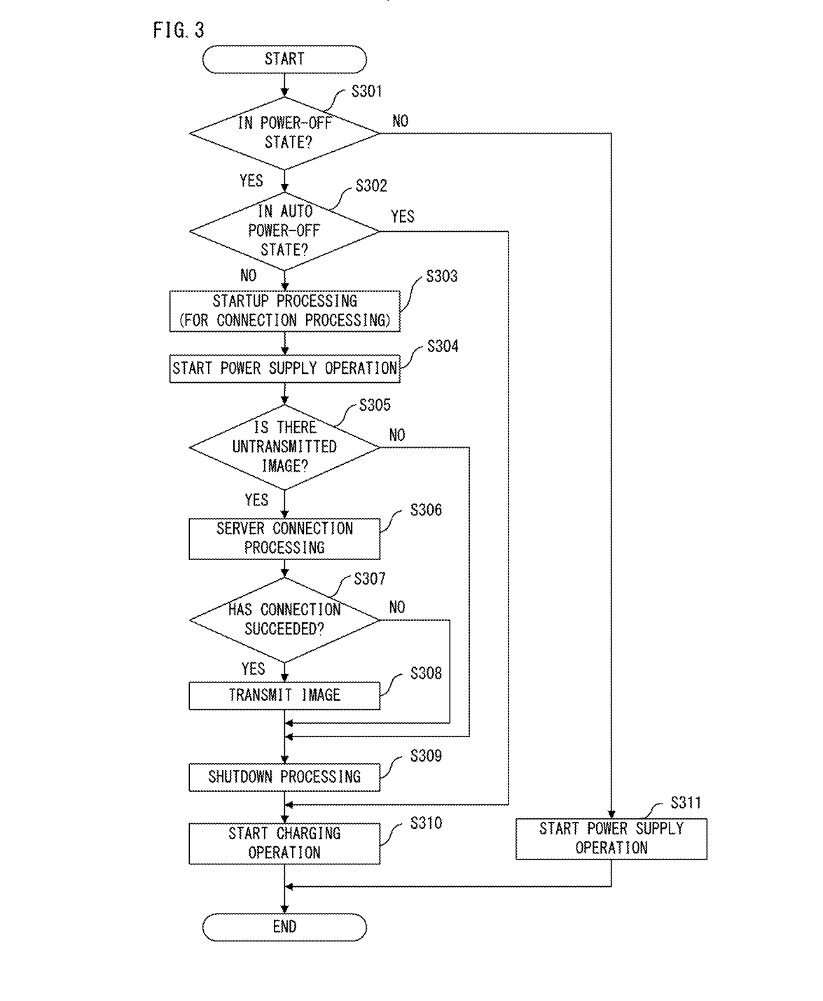

(Processing of Digital Camera 100) Next, with reference to the flowchart illustrated in FIG. 3, processing executed by the digital camera 100 of the present embodiment will be described. The processing illustrated in FIG. 3 is started by the control unit 101, as one example, by an external power source being connected to the power supply unit 110 of the digital camera 100 and the power supply from the external power source to the digital camera 100 being started. Furthermore, the processing illustrated in FIG. 3 is implemented by the control unit 101 loading a program read from the non-volatile memory 103 into the work memory 104 and executing the program.

In step S301, the control unit 101 determines whether the digital camera 100 is in a power-off state or not. In the case where the control unit 101 determines that the digital camera 100 is in a power-off state (S301: YES), the processing proceeds to step S302. In addition, in the case where the control unit 101 determines that the digital camera 100 is not in a power-off state (S301: NO), the processing proceeds to step S311. Note that the power-off state of the digital camera 100 includes a normal power-off state in which the power lever 105d is at the power-off position, and an auto power-off state in which the power lever 105d is at the power-on position and the power supply to each unit is at a level equivalent to that in the power-off state. Also, in the digital camera 100 having a power button instead of the power lever 105d, the power-off state may only include the normal power-off state; however, the present embodiment is applicable to such a digital camera 100 as well.

Here, the normal power-off state in which the power lever 105d is at the power-off position is the first power-off state, and the auto power-off state is the second power-off state. Note that the first power-off state is a power-off state capable of accepting the operations from the user on a first number of operation components including a power switching component. In addition, the second power-off state is a power-off state capable of accepting the operations from the user on a second number of operation components including a power switching component, which is greater than the first number. Further, when the operable operation components are restricted in the first power-off state compared with the second power-off state, the operation components other than the power lever 105d may be operable in the first power-off state.

In step S302, the control unit 101 determines whether or not the digital camera 100 is in an auto power-off state. In the case where the control unit 101 determines that the digital camera 100 is in an auto power-off state (S302: YES), the processing proceeds to step S310. In addition, in the case where the control unit 101 determines that the digital camera 100 is not in an auto power-off state (S302: NO), the processing proceeds to step S303.

In step S303, the control unit 101 performs startup processing for executing connection processing between the digital camera 100 and the server 202. Here, the startup processing for executing the connection processing is the startup processing intended only for establishing a connection with the server 202 via the AP 201, and aims to suppress power consumption compared to normal startup processing of the digital camera 100. In the startup processing of this step, the control unit 101, for example, does not perform the startup processing of the image capture unit 102, so that power supply from the power control unit 108 to the image capture unit 102 is not carried out, making it possible to suppress power consumption of the digital camera 100. Note that if normal startup processing of the digital camera 100 is performed after the startup processing in this step, the control unit 101 executes shutdown processing of the digital camera 100 once, so it takes time to start up the digital camera 100. Therefore, in the present embodiment, the control unit 101 suppresses power consumption of the digital camera 100 by not executing the normal startup processing of the digital camera 100 in the startup processing of this step.

In step S304, the control unit 101 starts a power supply operation of the digital camera 100. By issuing an instruction to the power control unit 108, the control unit 101 supplies power, which is supplied from an external power source connected to the power supply unit 110, to each unit of the digital camera 100. In this way, the operation for supplying power, which is supplied from an external power source connected to the power supply unit 110, to each unit of the digital camera 100 is called a power supply operation.

In step S305, the control unit 101 determines whether or not an image that has not yet been transmitted to the server 202 is recorded on the recording medium 107. In the case where the control unit 101 determines that there is an untransmitted image on the recording medium 107 (S305: YES), the processing proceeds to S306. In addition, in the case where the control unit 101 determines that there is no untransmitted image on the recording medium 107 (S305: NO), the processing proceeds to S309. Note that the determination as to whether or not an image is an untransmitted image may be performed by the control unit 101 referring to the header area of each image, or may be performed by separately creating a file for managing the transfer status in the recording medium 107 and referring to this file.

In step S306, the control unit 101 executes connection processing with the server 202. In the present embodiment, in order to connect to the server 202, the digital camera 100 detects a beacon signal periodically transmitted by means of the AP 201, which is an external relay apparatus, and joins the wireless LAN network formed by the AP 201.

In step S307, the control unit 101 determines whether or not the connection with the server 202 has succeeded. In the case where the control unit 101 determines that the connection with the server 202 has succeeded (S307: YES), the processing proceeds to S308. In addition, in the case where the control unit 101 determines that the connection with the server 202 has failed (S307: NO), the processing proceeds to S309. As described above, the digital camera 100 joins in the wireless LAN network formed by the AP 201 in order to connect to the server 202. Therefore, if the digital camera 100 cannot join the wireless LAN network formed by the AP 201, the control unit 101 also determines that the connection with the server 202 has failed.

In step S308, the control unit 101 transmits, to the server 202, images among the images stored in the recording medium 107 of the digital camera 100 that have not been transmitted to the server 202. For example, information indicating whether or not an image has already been transmitted to the server 202 is stored in the header area of the image, and the control unit 101 can determine images that have not been transmitted to the server 202 by using the information in the header area of the images. Furthermore, after transmitting an untransmitted image to the server 202, the control unit 101 rewrites the information in the header area of the transmitted image to information indicating that the image has already been transmitted to the server 202.

Instead of this or in addition to this, the control unit 101 may store, in the recording medium 107, a file that manages whether or not an image has already been transmitted to the server 202. In this case, after transmitting an untransmitted image to the server 202, the control unit 101 rewrites the file so as to indicate that the transmitted image has already been transmitted to the server 202. Note that the control unit 101 repeatedly executes the processing of this step until in the recording medium 107, there are no more images untransmitted to the server 202. Although not illustrated, if the connection between the digital camera 100 and the server 202 is disconnected during image transmission in this step, the control unit 101 proceeds the processing to step S309.

In step S309, the control unit 101 performs shutdown processing of the digital camera 100. Through the execution of the shutdown processing by the control unit 101, the digital camera 100 transitions to a state in which power supply from the power control unit 108 to each unit is set to a minimum necessary.

In step S310, the control unit 101 starts a charging operation of the digital camera 100. By issuing an instruction to the power control unit 108, the control unit 101 causes the power control unit 108 to supply power, which is supplied from an external power source connected to the power supply unit 110, to the power source unit 109. In this way, the operation in which the power control unit 108 supplies power, which is supplied from an external power source connected to the power supply unit 110, to the power source unit 109 to charge the power source unit 109 is called the charging operation.

In step S311, the control unit 101 starts a power supply operation of the digital camera 100 similarly to the processing of step S304. By issuing an instruction to the power control unit 108, the control unit 101 supplies power, which is supplied from an external power source connected to the power supply unit 110, to each unit of the digital camera 100.

According to the present embodiment, when the digital camera 100 performs wireless communication with the server 202 in a power-off state, it does not perform wireless communication in the case where it is in an auto power-off state. Furthermore, even when the digital camera 100 is turned off by means of the power lever 105d, if there is no power supply from an external power source, the control unit 101 does not perform wireless communication. Accordingly, in the digital camera 100, processing related to communication with the server 202 is not required in the auto power-off state, and therefore it is possible to further shorten the time required for the digital camera 100 to return to a state capable of image capture.

### Second Embodiment

Next, the communication system according to the second embodiment of the present disclosure will be described. Note that in the following description, configurations and processing similar to those of the communication system 1 according to the first embodiment are denoted by the same reference numerals, and detailed description thereof is omitted.

In the communication system 1 according to the second embodiment, when the digital camera 100 executes an update of the firmware in a power-off state, it determines whether or not to connect to the server 202 in order to check whether there is the latest firmware and download it.

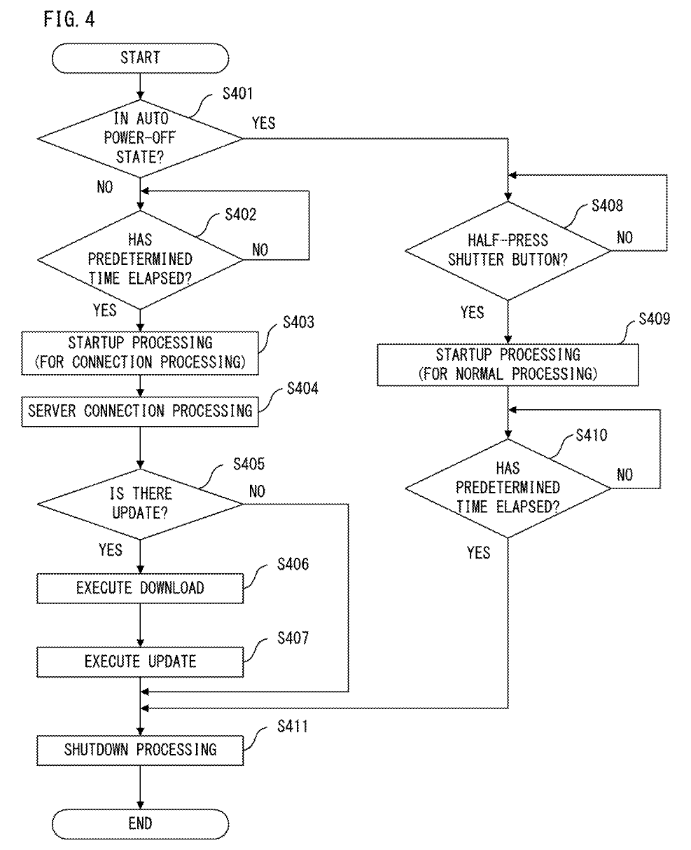

(Processing of Digital Camera 100) Next, with reference to the flowchart illustrated in FIG. 4, processing executed by the digital camera 100 of the present embodiment will be described. The processing illustrated in FIG. 4 is, as an example, started by the control unit 101 due to the power of the digital camera 100 being turned off. Furthermore, the processing illustrated in FIG. 4 is implemented by the control unit 101 loading a program read from the non-volatile memory 103 into the work memory 104 and executing the program.

In step S401, the control unit 101 determines whether or not the digital camera 100 is in an auto power-off state. In the case where the control unit 101 determines that the digital camera 100 is in an auto power-off state (S401: YES), the processing proceeds to step S408. In addition, in the case where the control unit 101 determines that the digital camera 100 is not in an auto power-off state (S401: NO), the processing proceeds to step S402.

In step S402, the control unit 101 determines whether or not a predetermined time has elapsed since the digital camera 100 is put into a power-off state. If the control unit 101 determines that a predetermined time has elapsed since the digital camera 100 is put into a power-off state (S402: YES), the processing proceeds to step S403. In addition, if the control unit 101 determines that a predetermined time has not elapsed since the digital camera 100 is put into a power-off state (S402: NO), the processing of step S402 is repeated. Processing of steps S403 and S404 is the same as that of steps S303 and S306 according to the first embodiment, respectively.

Next, in step S405, the control unit 101 determines whether or not there is an update of the firmware of the digital camera 100. In the case where the control unit 101 determines that there is an update of the firmware of the digital camera 100 (S405: YES), the processing proceeds to step S406. In addition, in the case where the control unit 101 determines that there is no update of the firmware of the digital camera 100 (S405: NO), the processing proceeds to step S411.

Note that in this step, the determination method executed by the control unit 101 for determining whether there is an update of the firmware of the digital camera 100 is not limited to the above determination method. The determination method may, for example, be a method in which the control unit 101 notifies the server 202 of the firmware version of the digital camera 100 and receives from the server 202 a determination result regarding whether there is an update of the firmware. Alternatively, the determination method may be a method in which the control unit 101 receives the latest firmware version information of the digital camera 100 from the server 202, and the control unit 101 determines whether there is an update on the basis of the received information.

In step S406, the control unit 101 downloads the latest firmware of the digital camera 100 from the server 202. Note that the control unit 101 may save the downloaded firmware in the recording medium 107 or may temporarily save it in the work memory 104.

In step S407, the control unit 101 executes an update of the firmware of the digital camera 100 using the firmware acquired from the server 202 in step S406. Note that the control unit 101 may automatically execute the update of this step after downloading the latest firmware of the digital camera 100 in step S406. Alternatively, the control unit 101 may execute the update upon detecting that the user has performed a predetermined operation on the operation unit 105 for executing the update.

In step S408, the control unit 101 determines whether the shutter button 105a is half-pressed. If the control unit 101 determines that the shutter button 105a is half-pressed (S408: YES), the processing proceeds to step S409. In addition, if the control unit 101 determines that the shutter button 105a is not half-pressed (S408: NO), the processing of step S408 is repeated. Note that the digital camera 100 of the present embodiment, when in the auto power-off state, returns from the auto power-off state when the shutter button 105a is half-pressed. However, the digital camera 100 of the present embodiment may also return from the auto power-off state when the user operates other operation units 105. That is, the control unit 101 may be configured such that the digital camera returns from the auto power-off state upon receipt of an operation of an operation unit other than the power lever 105d. In this case, in step S408, the control unit 101 determines whether or not an operation of an operation unit other than the power lever 105d has been performed. Then, when the control unit 101 determines that an operation of an operation unit other than the power lever 105d has been performed, the processing proceeds to step S409, and when the control unit 101 determines that an operation of an operation unit other than the power lever 105d has not been performed, the processing of step S408 is repeated.

In step S409, the control unit 101 performs startup processing for executing normal processing of the digital camera 100. Here, the startup processing for executing normal processing is the startup processing for bringing the digital camera 100 into a state capable of executing various functions of the digital camera 100.

In step S410, the control unit 101 determines whether or not a predetermined time has elapsed since the digital camera 100 completed the startup processing for executing normal processing, or since the operation unit 105 is last operated. If the control unit 101 determines that a predetermined time has elapsed (S410: YES), the processing proceeds to S411. In addition, if the control unit 101 determines that a predetermined time has not elapsed (S410: NO), the processing of step S410 is repeated. The processing of step S411 is the same as the processing of step S309.

According to the present embodiment, when the digital camera 100 performs wireless communication with the server 202 in a power-off state, it does not perform wireless communication in the case where it is in an auto power-off state. Accordingly, in the digital camera 100, processing related to communication with the server 202 is not required in the auto power-off state, and therefore it is possible to further shorten the time required for the digital camera 100 to return to a state capable of image capture.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

According to the technique of the present disclosure, it is possible to provide an image capture apparatus that performs wireless communication when the power is off, which can further shorten the time required to return to a state capable of image capture in the power-off state.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-214407, filed on December 9, 2024, which is hereby incorporated by reference herein in its entirety.

What is claimed is:

1. An image capture apparatus, comprising:
a communication device that communicates with an external apparatus outside the image capture apparatus;
a plurality of operation components including a power switching component that switches power of the image capture apparatus on and off;
a processor; and
a memory storing a program which, when executed by the processor, causes the image capture apparatus to:
execute control processing in which in a first power-off state capable of accepting operations from a user on a first number of operation components including the power switching component, the communication device performs communication with the external apparatus, and in a second power-off state capable of accepting operations from the user on a second number of operation components including the power switching component, which is larger than the first number, the communication device is controlled so as not to perform communication with the external apparatus.

2. The image capture apparatus according to claim 1, wherein in the control processing, even in the first power-off state, if power is not supplied from an external power source of the image capture apparatus to the image capture apparatus, the communication device is controlled so as not to perform communication with the external apparatus.

3. The image capture apparatus according to claim 2, wherein the program, when executed by the processor, further causes the image capture apparatus to
execute charging processing that executes charging of the image capture apparatus, and
in the charging processing, charging of the image capture apparatus is performed when the communication device is not performing communication with the external apparatus.

4. The image capture apparatus according to claim 1, wherein the first power-off state is a state after the user turns off the power of the image capture apparatus by operating the power switching component, and
the second power-off state is a state after the power of the image capture apparatus is turned off without an operation being performed on the power switching component.

5. The image capture apparatus according to claim 1, wherein the communication device communicates with the external apparatus to transmit an image.

6. The image capture apparatus according to claim 1, wherein the communication device communicates with the external apparatus for performing an update of a firmware of the image capture apparatus.

7. An image capture apparatus control method, wherein
the image capture apparatus comprises:
a communication device that communicates with an external apparatus outside the image capture apparatus; and
a plurality of operation components including a power switching component that switches power of the image capture apparatus on and off;
the control method comprising:
in a first power-off state capable of accepting operations from a user on a first number of operation components including the power switching component, controlling the communication device so as to perform communication with the external apparatus; and
in a second power-off state capable of accepting operations from the user on a second number of operation components including the power switching component, which is larger than the first number, controlling the communication device so as not to perform communication with the external apparatus.

8. A non-transitory computer readable medium that stores a program, wherein the program causes an image capture apparatus to execute a control method, wherein
the image capture apparatus comprises:
a communication device that communicates with an external apparatus outside the image capture apparatus; and
a plurality of operation components including a power switching component that switches power of the image capture apparatus on and off;
the control method comprising:
in a first power-off state capable of accepting operations from a user on a first number of operation components including the power switching component, controlling the communication device so as to perform communication with the external apparatus; and
in a second power-off state capable of accepting operations from the user on a second number of operation components including the power switching component, which is larger than the first number, controlling the communication device so as not to perform communication with the external apparatus.
